(19) United States
(12) Patent Application Publication
(10) Pub. No.: US 2021/0171353 A1
(43) Pub. Date: Jun. 10, 2021

(54) CARBONACEOUS MATERIALS AND METHODS OF USE THEREOF

(71) Applicant: Imerys Graphite & Carbon Switzerland Ltd., Bodio (CH)

(72) Inventors: Michal GULAS, Malvaglia (CH); Michael SPAHR, Bellinzona (CH); Patrick LANZ, Bellinzona (CH); Pirmin ULMANN, Giubiasco (CH); Hiroyuki MORIOKA, Kanagawa (JP); Hiroyuki TAKI, Tokyo (JP); Milka NISHIKAWA, Kanagawa (JP); Kanako TAKIZAWA, Tokyo (JP); Hiromasa WATANABE, Kanagawa (JP)

(21) Appl. No.: 16/071,121

(22) PCT Filed: Jan. 20, 2017
(86) PCT No.: PCT/EP2017/051255

§ 371 Date: Jul. 19, 2018

(30) Foreign Application Priority Data
Jan. 21, 2016 (EP) 16152322.0

(51) Int. Cl. C01B 32/23; C08L 87/00

(52) U.S. Cl. CPC C01B 32/23; C08L 87/00; C01P 2006/12; C08K 3/042; C01P 2002/82; C01P 2002/02; C01P 2006/80; C01P 2004/51

(57) ABSTRACT

The present disclosure relates to compositions comprising at least two different carbonaceous components, at least one being a surface-modified carbonaceous particulate material typically having a relatively high spring-back, and at least one other component being a carbonaceous particulate material (such as graphite) generally having a lower spring-back and/or a higher BET specific surface area than the surface-modified carbonaceous material component. Such compositions are particularly useful for making negative electrodes for lithium-ion batteries and the like in view of their beneficial electrochemical properties, particularly in automotive and energy storage applications. The present disclosure also relates to the use of a low-spring-back carbonaceous particulate materials as an additive in carbonaceous compositions, wherein said compositions are used to prepare anodes for Li-ion batteries in order to increase the electrode density, the cell capacity and/or the cycling stability of said battery while maintaining the power density of the cell compared to a cell with an anode absent the carbonaceous additive.

### FIELD OF THE DISCLOSURE

The present disclosure relates to compositions comprising at least two different carbonaceous components, at least one being a surface-modified carbonaceous particulate material typically having a relatively high spring-back, and at least one other component being a carbonaceous particulate material (such as graphite) generally having a lower spring-back and/or a higher BET specific surface area than the surface-modified carbonaceous material component. Such compositions are particularly useful for making negative electrodes for lithium-ion batteries and the like in view of their electrochemical properties, particularly in automotive and energy storage applications.

The present disclosure also relates to the use of a low-spring-back carbonaceous particulate materials as an additive in carbonaceous compositions, wherein said compositions are used to prepare anodes for Li-ion batteries, e.g., in order to increase the electrode density, the cell capacity and/or the cycling stability of said battery while maintaining the power density of the cell compared to a cell with an anode absent the carbonaceous additive.

### BACKGROUND

Lithium-ion batteries have become the battery technology of choice for consumer electronics like laptop computers, smart phones, video cameras, and digital still cameras. Compared to other battery chemistries, one of the advantages of the lithium-ion battery system relates to the high energy density and specific energy combined with a high power performance due to an average cell voltage of about 3.5 V and the light weight electrode materials. Over the last more than 20 years since the introduction of the first lithium-ion battery by Sony Corp. in 1991, lithium-ion cells could be significantly improved in terms of energy density. This development was inter alia motivated by the increased energy consumption and the trend to miniaturization of the electronic devices that requires decreased accumulator volumes and increased electrochemical cell capacities.

In recent years, lithium-ion batteries have also been considered for automotive applications like hybrid, plug-in, and full electric vehicles, as well as for energy storage systems, for example when integrated into the electric grid in order to buffer peak consumption of electricity in the electric grid and to integrate renewable energy generation like wind and solar energy generation typically being variable in occurrence.

For automotive applications the energy of the cell per volume (cell capacity or energy density) and per weight (specific energy) plays an important role for the improvement of the limited driving range, which is still a major obstacle for electric vehicles. At the same time the charging speed, cycling stability and durability of the battery are even more important for such applications than for consumer electronics batteries due to the significantly higher longevity required by the automotive industry, electricity providers and final users of such batteries.

Because batteries used for energy storage applications are mostly stationary battery applications, cell volume and weight are less important compared to other, e.g., mobile applications. On the other hand, the cell durability and the number of charge and discharge cycles with a given capacity retention are important parameters in such applications. This comes along with ensuring the utmost level of battery safety which is an important prerequisite for the proliferation of the lithium cell technology for all desired applications.

Although the parallel improvement of all major cell parameters such as energy density, power density, durability, and safety would be desirable, improving one parameter often negatively influences other cell parameters. For example, the energy density typically cannot be increased without losing power density, safety, or durability, or vice versa. Thus, in the cell design and engineering of a Li-ion battery, the skilled person must usually accept a trade-off between the various cell parameters.

One important component influencing the electrochemical properties of a Li-ion cell is the negative electrode (anode). In some Li-ion batteries, the anode comprises carbonaceous materials such as graphite as an electrochemically active material. Since the carbon material is involved in the electrochemical redox process occurring at the electrodes by intercalating and de-intercalating lithium during the charging and discharging process, respectively, the properties of the carbonaceous material are expected to play an important role in the performance characteristics of the battery. It is well accepted in the field of technology that the graphite negative electrode is limited in terms of charge acceptance and therefore is the main cause of limitations concerning the charging speed, which is an important requirement, especially for automotive lithium-ion batteries.

For these reasons, a variety of different carbonaceous materials such as graphites have been developed in the art. For example, WO 2013/149807 to Imerys Graphite & Carbon describes surface-modification processes for graphitic particles obtainable by either an oxidative treatment or, alternatively, by chemical vapor deposition (CVD) coating, which provides graphite materials having improved surface properties. Although both processes are fundamentally different from each other and produce distinct graphitic particles, both processes lead to graphite particles having advantageous properties over unmodified graphite per se. Co-pending PCT application published as WO 2016/008951 A1 (PCT/EP2015/066212), also to Imerys Graphite & Carbon, discloses surface-modified carbonaceous materials such as graphite, wherein the unmodified natural or synthetic carbon precursor is first subjected to an amorphous carbon coating (e.g. by CVD), followed by exposing the coated material to an oxygen-containing atmosphere. This procedure results in surface-modified carbonaceous particles that are more hydrophilic compared to the amorphous carbon-coated particles before the surface oxidation (“activation”).

It was an object to provide a carbonaceous material useful as an active material in negative electrodes for lithium-ion batteries. In particular, there is a continued need in the art for a carbonaceous material with beneficial properties when used as active material in negative electrodes for lithium ion batteries in automotive applications (electric vehicles, etc.), or energy storage applications. Particularly in such applications, it is desirable to improve cycling performance and durability without, however, at the same time sacrificing cell capacity and cell power.

### SUMMARY OF THE DISCLOSURE

The present inventors have surprisingly found that combining at least two different carbonaceous (such as graphitic) materials into a composition of carbonaceous particles and using such composition in an electrode, e.g., a negative electrode, yields electrodes that may improve the cycling performance (e.g., cycling stability), durability, electrode resistance, current discharge properties, reversal capacity, and/or safety of lithium-ion batteries while maintaining their cell capacity and cell power.

Thus, in a first aspect, the present disclosure relates to a composition comprising at least one surface-modified carbonaceous particulate material typically characterized by a higher spring-back, for example of ≥ (i.e., greater than or equal to) about 20%, or ≥ about 30%, or ≥ about 40% (“high spring-back surface-modified carbonaceous particles”), and, as a further component, at least one carbonaceous particulate material (e.g. graphite) characterized by a lower spring-back than the first component, for example a spring-back of ≤ (i.e., less than or equal to) about 18%, or ≤ about 15% (“low spring-back carbonaceous particles”). For example, the spring-back of the first, surface-modified (high spring back) carbonaceous particulate material may range from about 20% to about 70%, such as from about 20% to about 25%, from about 25% to about 65%, from about 30% to about 60%, from about 35% to about 55%, from about 40% to about 60%, from about 45% to about 55%, from about 50% to about 60%, from about 55% to about 65%, or from about 55% to about 60%. Further, for example, the spring-back of the second (low-spring back) carbonaceous particulate material may range from about 5% to about 15%, such as from about 5% to about 7%, from about 5% to about 10%, from about 5% to about 12%, from about 7% to about 12%, from about 10% to about 15%, or from about 12% to about 15%. In some embodiments, the first, surface-modified (high spring-back) carbonaceous particulate material may have a spring-back that is at least 2% greater, at least 5% greater, at least 10% greater, at least 15% greater, at least 20% greater, or at least 25% greater than the spring back of the second (low spring-back) carbonaceous particulate material. For example, the difference in spring-back between the first, surface-modified (high spring-back) carbonaceous particulate material and the second (low spring-back) carbonaceous particulate material may range from 2% to about 30%, from 5% to 25%, from 10% to 20%, from 10% to 25%, from 5% to 15%, or from 10% to 25%. Thus, for example, the first, surface-modified (high spring-back) carbonaceous particulate material may have a spring back ranging from about 20% to about 70% and the second (low spring-back) carbonaceous material may have a spring back ranging from about 5% to about 15%. As another example, the first, surface-modified (high spring-back) carbonaceous particulate material may have a spring back ranging from about 40% to about 60% and the second (low spring-back) carbonaceous material may have a spring back ranging from about 10% to about 15%. In yet another example, the first, surface-modified (high spring-back) carbonaceous particulate material may have a spring back ranging from about 55% to about 65% and the second (low spring-back) carbonaceous material may have a spring back ranging from about 5% to about 12%. Other combinations in accordance with the foregoing discussion are likewise contemplated and encompassed herein. Typically, the BET SSA of the low spring-back carbonaceous particulate material is higher than the BET SSA of the surface-modified carbonaceous material.

In some embodiments, the high spring-back surface-modified carbonaceous particles can be characterized by a core of natural or synthetic graphite wherein their surface has been modified according to a chemical process and/or characterized by a relatively low BET specific surface area (BET SSA) of below about 20 m²/g, such as between 4.1 m²/g and 20 m²/g. In some embodiments, for example, the surface of the carbonaceous (e.g., natural or synthetic graphite) particles may be oxidized and/or may undergo processes that affect crystallinity of the surface. Such processes may include, but are not limited to, the processes set out in WO 2013/149807 or PCT/EP2015/066212, respectively. The high spring-back surface-modified carbonaceous particles can be characterized by a relatively low BET specific surface area (BET SSA) of below about 20 m²/g, 15, m²/g, 10 m²/g, or even below about 6 to 8 m²/g. Optionally their BET SSA may be between 4.1 m²/g and 20 m²/g, or between 4.5 m²/g and 15 m²/g or between 4.1 m²/g and 10 m²/g. The low spring-back carbonaceous particulate material, which may typically be present in an amount of up to 30 wt %, may in these embodiments be characterized as a highly crystalline unmodified graphitic material with a BET SSA generally higher than the BET SSA of the surface-modified high spring-back graphite, e.g. having a BET SSA of more than about 5, 6, 7, 8, or 10 m²/g.

As shown in the Example section infra, such a combination of at least two different carbonaceous materials can be advantageously used for improving the cycling performance and durability/safety without negatively affecting the cell capacity and cell power of lithium ion batteries, which is particularly useful in automotive and energy storage applications.

Another, related aspect of the present disclosure thus is the use of a composition as defined herein for making a negative electrode of a Li-ion battery.

As noted above, such electrodes, and the corresponding Li-ion batteries, are particularly useful in automotive or energy storage applications, such as electric vehicles, hybrid electric vehicles, or energy storage cells. Accordingly, further aspects of the present disclosure include an electrode, a lithium-ion battery, or an electric vehicle, a hybrid electric vehicle, or an energy storage cell comprising the composition as described herein as an active material in the anode of said Li-ion battery.

The use of a low spring-back carbonaceous material as defined herein as a carbonaceous additive to increase the cell capacity and/or the cycling stability of a Li-ion battery while maintaining the power density of the cell compared to a cell with an anode absent the carbonaceous additive represents another aspect of the present disclosure.

Moreover, the use of a low spring-back carbonaceous particulate material as defined herein as a carbonaceous additive to increase the density of an anode of a Li-ion battery while maintaining the power density of the cell compared to a cell with an anode absent the carbonaceous additive is yet another aspect of the present disclosure.

### DETAILED DESCRIPTION

The present inventors have found that by carefully selecting at least two different carbonaceous components, carbonaceous compositions having favorable properties when used as an active material in negative electrodes of Li-ion batteries can be obtained.

Thus, in one aspect, the present disclosure provides a composition comprising at least one surface-modified carbonaceous particulate material and at least one other carbonaceous particulate material having a lower spring-back than the surface-modified carbonaceous particulate material (“low spring-back carbonaceous material”). Typically, the BET SSA of the at least one low spring-back carbonaceous material is higher than the BET SSA of the at least one surface-modified carbonaceous particulate material. The term “surface-modified” in connection with graphite or carbonaceous particles is generally understood in the art to refer to particles whose surface has been modified chemically, e.g., by introducing additional functional groups on the surface of the carbonaceous particle, or by adding a layer (which may be complete or incomplete) of amorphous or at least essentially non-crystalline carbon on the surface of the carbonaceous particle. Introducing additional functional groups can for example achieved by exposing carbonaceous particles to oxygen (or species that are capable of releasing oxygen) under controlled conditions (as opposed to a simple exposure of particles to air which may or may not be sufficient to change the chemical constitution of the surface of the particles). Adding amorphous/non-graphitic carbon is typically achieved by pitch-coating, plasma polymerization or various vapor deposition techniques (such as CVD and the like). The term “surface-modified” as used herein in other words does not include surface modifications that are caused by other, non-chemical means, e.g. by merely mechanical manipulations of the particles, such as milling, grinding or abrasion (i.e. “polishing” instead of crushing the particles in order to modify their shape only but not reducing their size in a significant manner).

In some embodiments, the first, surface-modified carbonaceous particulate material has a spring-back of ≥ about 20%, or ≥ about 30%, or even ≥ about 40%. In such embodiments, this component is referred to as a “high spring-back surface-modified carbonaceous particulate material” (or particles). The term “about” as used herein refers to being nearly the same as a referenced amount or value, and should be understood to encompass ±5% of the specified amount or value.

In certain embodiments, the first (typically high spring-back) surface-modified carbonaceous particulate material may be further characterized by a BET SSA of less than 20 m²/g, or less than 15 m²/g, or between 1 and 10 m²/g, or between 1 and 8 m²/g, or between 1 and 6 m²/g. In some embodiments, the BET SSA of said surface-modified carbonaceous particulate material may be higher than 4.0 m²/g, such as at least 4.1, 4.2, 4.3, 4.4 or 4.5 m²/g. Thus, in certain embodiments, the BET SSA of said surface-modified carbonaceous particulate material may be at least 4.1, 4.2, 4.3, 4.4 or 4.5 m²/g but lower than 20 m²/g, or lower than 15 m²/g, or lower than 10 m²/g.

The surface-modified carbonaceous particulate material can in some embodiments be further characterized by a number of additional parameters, alone or in any possible combination:
a) a crystallite size L_{c} (as measured by XRD) from 50 to 400 nm, or from 60 to 200 nm, or from 80 to 180 nm, or from 100 to 150 nm;
b) a crystallite size Lₐ (as measured by Raman spectroscopy) from 5 to 100 nm, from 5 to 60 nm, or from 6 to 40 nm;
c) a ratio of L_{c}/Lₐ of greater than 1.0, 1.5, 2.0, 2.5, or 3.0;
d) a c/2 distance of between about 0.3353 and 0.3370 nm, or between about 0.3354 and 0.3365 nm;
e) an oxygen content of greater than 50 ppm, or greater than 90 ppm, or greater than 110 ppm;
f) a Fe content of below 20 ppm, or below 10 ppm, or below 5 ppm; and/or
g) an ash content of below 0.04, or below 0.01%, or below 0.005%.

In some embodiments, the at least one surface-modified carbonaceous particulate material may be further characterized by one or more of the following parameters, alone or in any combination:
h) a pH value in aqueous suspension ranging from about 5.0 to about 7.0, or from 5.0 to 6.5, or from 5.2 to 6, or from 5.3 to 5.5;
i) a xylene density from about 2.24 to 2.26 g/cm³, or from about 2.245 to 2.255 g/cm³, or from about 2.25 and 2.255 g/cm³; and/or
j) an I_{D}/I_{G} ratio (R(ID/IG)) of below about 0.3, or below about 0.25, or below about 0.2, or below about 0.15 when measured with a laser having an excitation wavelength of 632.8 nm (see method section below for further details on the determination of this parameter). In such embodiments, the surface modified carbonaceous material can for example be obtained by exposing the carbonaceous material, such as natural or synthetic graphite to an oxygen-containing atmosphere for a defined period of time.

Suitable methods are for example described in more detail in WO 2013/149807 which is incorporated herein by reference in its entirety. For example, oxidation of synthetic graphite with a BET surface area ranging from 1 m²/g to about 15 m²/g at temperatures from 500 to 1100° C. with treatment times ranging from 2 to 30 minutes may yield surface-modified graphite that can be used as one component in the claimed compositions. It will be understood that certain adaptions may be necessary (e.g. length of exposure to oxygen-containing gas, choice of starting material, etc.) in order to obtain a material exhibiting the desired parameters outlined above.

In other embodiments, the at least one surface-modified carbonaceous particulate material in the composition may be characterized by comprising carbonaceous core particles coated with a non-graphitic, e.g. amorphous, carbon coating. The at least one surface-modified carbonaceous particulate material in these embodiments may be further characterized by any one of the following parameters, alone or in combination:
k) a xylene density ranging from 2.2 to 2.255 g/cm³, or from 2.23 to 2.25 g/cm³;
l) a crystallite size L_{c} ranging from 80 to 350 nm, or from 100 to 160 nm;
m) a crystallite size Lₐ ranging from 5 to 100 nm, or from 20 to 60 nm;
n) an I_{D}/I_{G} ratio (R(I_{D}/I_{G})) of larger than about 0.3, or between about 0.4 and 1.0, when measured with a laser having an excitation wavelength of 632.8 nm; and/or
o) an oxygen content of greater than 80 ppm, or greater than 200 ppm, or greater than 300 ppm.

The at least one surface-modified carbonaceous particulate material coated with a non-graphitic material may in such embodiments for example be obtained by chemical vapor deposition (CVD) or similar techniques. Suitable methods and resulting surface-modified carbonaceous particles that can be used in the context of the present disclosure are for example described in more detail in WO 2013/149807, the disclosure of which is, as noted earlier herein, incorporated by reference in its entirety.

For example, the amorphous carbon coating may be obtained by chemical vapor deposition of a powdered natural or synthetic graphite starting material at temperatures from 500 to 1200° C. with a hydrocarbon gas such as acetylene or propylene, typically mixed with an inert carrier gas such as nitrogen or argon, with treatment times typically ranging from 3 to 120 minutes in for example a rotary kiln or fluidized bed. Again, it will be understood that certain adaptations to the process may be necessary (e.g. length of exposure to hydrocarbon gas, choice of hydrocarbon gas and starting material, etc.) in order to obtain a material exhibiting the desired parameters outlined above.

In yet other embodiments, the at least one surface-modified carbonaceous particulate material is characterized by carbon core particles having a hydrophilic non-graphitic, such as amorphous, carbon coating. Such a hydrophilic non-graphitic carbon coating can for example be obtained by first coating carbonaceous core particles such as graphite with a layer of non-graphitic, e.g. amorphous, carbon (for example by CVD), and subsequently exposing the coated particles to an oxygen-containing gas atmosphere under controlled conditions, as described in PCT/EP2015/066212, which is incorporated by reference in its entirety. The exposure to an oxygen containing atmosphere may increase the hydrophilicity of the carbonaceous particulate material, and is, for the sake of convenience, also sometimes referred to herein as “activation”, or “surface-oxidation”. Accordingly, the carbon coating of said hydrophilic surface-modified carbonaceous particulate material is in certain embodiments comprised of oxidized amorphous carbon.

In some of these embodiments, the at least one hydrophilic surface-modified carbonaceous particulate material may be further characterized by an increased wettability, compared to non-oxidized (i.e. non-activated) coated particles. Thus, the increased wettability may be expressed by measuring the contact angle of a water drop on a flat surface of the carbonaceous material. In these embodiments, the at least one hydrophilic surface-modified carbonaceous particulate material may exhibit a wettability characterized by
(i) a contact angle after 3 seconds that is less than 90°, or less than 75°, or less than 70°, or less than 65°, and/or
ii) a contact angle after 5 seconds that is less than about 60°, or less than 40°, less than 30°, less than 25°, or less than 20°; and/or
(ii) a surface energy of said hydrophilic surface-modified carbonaceous particulate material of at least 59 mJ/m², or of at least 62, 67 or 70 mJ/m².

The at least one hydrophilic surface-modified carbonaceous particulate material in the composition may in certain embodiments be further characterized by
(iii) an oxygen content of greater than about 200 ppm, greater than about 400 ppm, greater than about 600 ppm, greater than about 700 ppm, or greater than about 800 ppm; and/or
(iv) a mesopore area of less than 10.0 m²/g, less than 8.0 m²/g, less than 5.0 m²/g, less than 4.0 m²/g, less than 3.8 m²/g or less than 3.6 m²/g.

Suitable methods and resulting hydrophilic surface-modified (coated) carbonaceous particles are for example described in more detail in PCT/EP2015/066212, the disclosure of which is, as noted earlier herein, incorporated by reference in its entirety.

In all of the above embodiments characterizing the at least one surface-modified carbonaceous particulate material, the carbonaceous core of said particles may be selected from natural graphite, synthetic graphite, coke, exfoliated graphite, graphene, few-layer graphene, graphite fibers, nanographite, non-graphitic carbon, carbon black, petroleum- or coal based coke, glassy carbon, carbon nanotubes, fullerenes, carbon fibers, hard carbon, graphitized fine coke, or mixtures thereof, or compositions of such carbon particles which further contain silicon, tin, bismuth, antimony, aluminum, silver, SiO_{X} (X=0.2-1.8), or SnOₓ (including SnO and SnO₂) particles. In some embodiments, the core particles are natural or synthetic graphite particles, or a mixture of natural or synthetic graphite particles and silicon or other heteroatom particles.

It is well understood that particulate materials can be further characterized by their particle size, and/or their particle size distribution (PSD). A variety of methods exist to determine the PSD of a particulate material (see method section for some examples of PSD determination).

Thus, in some embodiments, the at least one surface-modified carbonaceous particulate material may be further characterized by a particle size distribution where the D₉₀ ranges from 10 to 50 μm, or from 15 to 45 μm, or from 20 to 40 μm; and/or where the D₅₀ ranges from 5 to 40 μm, or from 7 to 30 μm, or from 10 to 25 μm.

The at least one surface-modified carbonaceous particulate material in the composition may optionally be further characterized by one of the following parameters:
i) a tapped density of greater than 0.7 g/cm³, or greater than 0.8 g/cm³, or greater than 0.9 g/cm³, or greater than 0.95 g/cm³, or greater than 1 g/cm³;
ii) a Fe content of below 20 ppm, or below 10 ppm, or below 5 ppm; and/or
iii) an ash content of below 0.04, or below 0.01%, or below 0.005%.

As noted above, the composition of the present disclosure further comprises at least one other carbonaceous material which has a lower spring-back compared to the first component, i.e. the surface-modified carbonaceous material. In some embodiments, the low spring-back carbonaceous particulate material may have a BET SSA that is higher than the BET SSA of the surface-modified carbonaceous particulate material.

Accordingly, this low-spring-back carbonaceous particulate material may in some embodiments be characterized by a spring-back of 5 about 18%, or ≤ about 16%, or ≤ about 15%, or ≤ about 12%.

Alternatively or in addition, the low-spring-back carbonaceous particulate material may further have a BET SSA of ≥ about 5 m²/g, or ≥ about 6 m²/g, or ≥ about 7 m²/g, or ≥ about 8 m²/g, or ≥ about 9 m²/g, or even ≥ about 10 m²/g.

The low-spring-back carbonaceous particulate material as the second component of the composition is typically a carbonaceous material that has not undergone any surface modification (i.e. a chemical modification as explained herein), such as coating with non-graphitic carbon or surface oxidation. On the other hand, the term unmodified in this context still allows purely mechanical manipulation of the carbonaceous particles because the particles in many embodiments need to be milled or otherwise subjected to other mechanical forces, for example in order to obtain the desired particle size distribution.

In some embodiments, the low-spring-back carbonaceous particulate material in the composition is natural or synthetic graphite, optionally a highly crystalline graphite.

As used herein, “highly crystalline” preferably refers to the crystallinity of the graphite particles characterized by the interlayer distance c/2, by the real density (Xylene density), and/or the size of the crystalline domains in the particle (crystalline size L_{c}). In such embodiments, a highly crystalline carbonaceous material may be characterized by a c/2 distance of ≤0.3370 nm, or ≤0.3365 nm, or ≤0.3362 nm, or ≤0.3360 nm, and/or by a Xylene density above 2.230 g cm⁻³, and/or by an L_{c} of at least 20 nm, or at least 40 nm, or at least 60 nm, or at least 80nm, or at least 100 nm, or more.

The at least one low spring-back carbonaceous material may optionally be further characterized by any one of the following parameters, alone or in combination:
i) a particle size distribution where the D₉₀ ranges from 3 to 50 μm, or from 5 to 30 μm, or from 6 to 27 μm, or from 10 to 20 μm;
ii) a particle size distribution where the D₅₀ ranges from 1 to 30 μm, or from 2 to 20 μm, or from 3 to 15 μm, or from 5 to 10 μm;
iii) a particle size distribution where the D₁₀ ranges from 0.5 to 10 μm, or from 1 to 7 μm, or from 1 to 5 μm, or from 2 to 4 μm;
iv) a crystallite size L_{c} (as measured by XRD) from 30 to 400 nm, or from 50 nm to 350 nm, or from 70 nm to 250 nm;
v) a Scott density of less than about 0.4 g/cm³, or less than about 0.3 g/cm³, or less than about 0.25 g/cm³;
vi) a xylene density from 2.24 to 2.27 g/cm³, or from 2.25 to 2.265 g/cm³, or from 2.255 and 2.265 g/cm³; and/or
vii) an I_{D}/I_{G} ratio (R(I_{D}/I_{G})) of below about 0.3, or below about 0.25, or below about 0.2, or below about 0.15 when measured with a laser having an excitation wavelength of 632.8 nm.

In all of the above embodiments characterizing the at least one low-spring-back carbonaceous material, said material may be selected from natural graphite, synthetic graphite, coke, exfoliated graphite, graphene, few-layer graphene, graphite fibers, nanographite, graphitized fine coke, or non-graphitic carbon, including hard carbon, carbon black, petroleum- or coal based coke, glassy carbon, carbon nanotubes, fullerenes, carbon fibers, mixtures of any of these materials, or compositions of such carbon particles which further contain silicon, tin, bismuth, antimony, aluminum, silver, SiO_{X} (X=0.2-1.8), or SnO_{X} (including SnO and SnO₂) particles. In some embodiments, the low-spring-back carbonaceous particles are selected from natural or synthetic graphite particles, or a mixture of natural and synthetic graphite particles.

As can be seen from the Examples, good results have been achieved with compositions wherein the low spring-back component is a synthetic or natural graphite with a spring-back of below 15%, a BET SSA of at least 8 m²/g, and a c/2 distance of ≤0.3358nm. As further shown in the Examples, the low-spring-back component may be a synthetic or natural graphite having a particle size distribution wherein the D₉₀ diameter ranges from 6 to 27 μm, the D₅₀ diameter ranges from 3 to 15 μm, and the D₁₀ diameter ranges from 1 to 5 μm.

The at least one low-spring-back carbonaceous particulate material is typically, but not necessarily present as the minor component of the composition (i.e. less than 50% by weight of the composition). In certain embodiments, the content of the low spring-back graphite is below about 30%, or below about 25%, or below about 20%, or between 1 and 25%, or between 2 and 25%, or between 2.5 and 20%, or between 2 and 18%, or between 2 and 15%, or between 2.5 and 15%, or between 5 and 15% or between 10 and 15% by weight of the composition.

As mentioned above, the first, surface-modified (high spring-back) carbonaceous particulate material may have a spring-back that is at least 2% greater, at least 5% greater, at least 10% greater, at least 15% greater, at least 20% greater, or at least 25% greater than the spring back of the second (low spring-back) carbonaceous particulate material. For example, the difference in spring-back between the first, surface-modified (high spring-back) carbonaceous particulate material and the second (low spring-back) carbonaceous particulate material may range from 2% to about 30%, from 5% to 25%, from 10% to 20%, from 10% to 25%, from 5% to 15%, or from 10% to 25%. In some embodiments, the spring-back of the first, surface-modified (high spring back) carbonaceous particulate material may range from about 20% to about 70%, such as from about 20% to about 25%, from about 25% to about 65%, from about 30% to about 60%, from about 35% to about 55%, from about 40% to about 60%, from about 45% to about 55%, from about 50% to about 60%, from about 55% to about 65%, or from about 55% to about 60%. Further, for example, the spring-back of the second (low-spring back) carbonaceous particulate material may range from about 5% to about 15%, such as from about 5% to about 7%, from about 5% to about 10%, from about 5% to about 12%, from about 7% to about 12%, from about 10% to about 15%, or from about 12% to about 15%. Thus, for example, the first, surface-modified (high spring-back) carbonaceous particulate material may have a spring back ranging from about 20% to about 70% and the second (low spring-back) carbonaceous material may have a spring back ranging from about 5% to about 15%. As another example, the first, surface-modified (high spring-back) carbonaceous particulate material may have a spring back ranging from about 40% to about 60% and the second (low spring-back) carbonaceous material may have a spring back ranging from about 10% to about 15%. In yet another example, the first, surface-modified (high spring-back) carbonaceous particulate material may have a spring back ranging from about 55% to about 65% and the second (low spring-back) carbonaceous material may have a spring back ranging from about 5% to about 12%. Other combinations in accordance with the foregoing discussion are likewise contemplated and encompassed herein.

Besides the two differing carbonaceous particulate materials described in detail above, the composition may optionally further comprise at least one carbonaceous additive, optionally wherein the content of said carbonaceous additive is between 0% and 10%, or between 0.5% and 5%, or between 1% and 4% by weight. Suitable carbonaceous additives include, but are not limited to, conductive materials such as natural graphite, synthetic graphite, coke, exfoliated graphite, graphene, few-layer graphene, graphite fibers, nanographite, graphitized fine coke, non-graphitic carbon, including hard carbon, carbon black, petroleum- or coal based coke, glassy carbon, carbon nanotubes, including single-walled nanotubes (SWNT), multiwalled nanotubes (MWNT), fullerenes, carbon fibers, or mixtures of any of these materials. For example, the composition may comprise at least one surface-modified particulate carbonaceous material, at least one carbonaceous particulate carbonaceous material (e.g., natural or synthetic graphite) having a lower spring-back than the at least one surface-modified particulate carbonaceous material, and carbon black.

The composition may optionally further comprise at least one non-carbonaceous component, optionally wherein the content of said non-carbonaceous component is larger than 3%, or larger than 5%, or larger than 10%. Suitable non-carbonaceous additives may include silicon, tin, bismuth, antimony, aluminum, silver, SiO_{X} (X=0.2-1.8), or SnOₓ (including SnO and SnO₂) particles.

In addition, since the compositions are particularly useful for preparing negative electrodes for Li-ion batteries, the composition may in some embodiments further comprise a polymer binder material. Suitable polymer binder materials include styrene butadiene rubber (SBR), acrylonitrile butadiene rubber (NBR), carboxymethyl cellulose (CMC), polyacrylic acid and derivatives, polyvinylidene fluoride (PVDF), or mixtures thereof, typically in an amount of between 1 and 5% by weight.

### Use of the Compositions Comprising At Least One Surface-Modified Carbonaceous Particulate Material and At Least One Other Carbonaceous Particulate Material

Since the compositions of the present disclosure may have beneficial combined properties when present as an active material in negative electrodes for Li-ion batteries, the compositions as defined herein can be used for preparing negative electrodes for Li-ion batteries, in particular Li-ion batteries empowering electric vehicles, or hybrid electric vehicles, or energy storage units.

Without intending to be bound by theory, it is believed that the compositions disclosed herein (e.g., combining a first carbonaceous particulate material comprising a surface-modified carbonaceous particulate material and a second carbonaceous particulate material comprising a natural or synthetic carbonaceous material that is not surface-modified) when used in an electrode (e.g., a negative electrode of a Li-ion battery) may provide for improved particle-to-particle contact to promote electrical conductivity without inhibiting the ability of the electrolyte to penetrate the electrode to ensure the required ionic conductivity in the electrode. For example, the second carbonaceous particulate material may comprise a relatively high-conductive material having low-spring-back and/or compressibility characteristics that, together with the conductive surface-modified carbonaceous material, provides a three-dimensional structure particularly suitable for electrochemical applications, e.g., as material for the anode of a Li-ion battery. As further noted above, the composition may comprise one or more additional high-conductivity carbonaceous materials, including, but not limited to, carbon black, which may or may not be chemically modified.

Again without intending to be bound by theory, it is believed that the amount of the second (low spring-back) carbonaceous material present may have a significant impact on battery performance, e.g., whereby increasing the amount of the second (low spring-back) carbonaceous particulate material may increase electrical conductivity until that amount is sufficiently high so as to fill spaces within the three-dimensional structure (created by the assembly of electrode materials of the negative electrode that then inhibits the ability of the liquid electrolyte to penetrate the electrode), and as a consequence limits the ionic conductivity which becomes essential especially for high current rate charge and discharge. As noted above, the composition may comprise less than 30% by weight of the second (low spring-back) carbonaceous particulate material, e.g., between 1% and 25%, between 2.5 and 20%, between 2 and 15%, between 2.5 and 15%, between 5 and 15% or between 10 and 15% by weight. For example, the composition may comprise at least 50% by weight of surface-modified carbonaceous particulate material (e.g., from 50% to 99%, from 70% to 98%, from 75% to 95%, from 85% to 95%, or from 80% to 90% by weight surface-modified carbonaceous particulate material), and from 1% to 20% by weight low spring-back carbonaceous particulate material (e.g., from 2% and 18%, from 2% to 15%, from 2.5% to 15%, from 5% to 15%, or from 10% to 15% by weight of low spring-back carbonaceous particulate material. Such compositions, when used in the anode of a Li-ion battery, may provide a suitable balance of cycling stability, electrode resistance, high current discharge properties, and high reversal capacity.

Thus, another aspect of the present disclosure relates to the use of a composition comprising at least one surface-modified carbonaceous particulate material having a high spring-back, for example of equal to or more than 20%, or equal to or more than 30%, or equal to or more than 40%, and at least one carbonaceous particulate material having a lower spring-back, for example equal to or below about 18%, or equal to or below about 15% for making a negative electrode of a Li-ion battery. Such Li-ion batteries are in some embodiments adapted for use in an electric vehicle, a hybrid electric vehicle, or an energy storage cell.

Typically, the use of the composition for making an anode of a Li-ion battery may involve a composition as defined herein.

### Downstream Products Employing the Surface-Modified Carbonaceous Particulate Materials

Consequently, a negative electrode of a lithium ion battery which comprises a composition as defined herein as an active material represents another aspect of the present disclosure. This includes electrodes where the negative electrodes comprise less than 100% of the carbonaceous particulate material according to the present disclosure as an active material. In other words, negative electrodes containing mixtures with yet other materials (graphite or otherwise) are likewise contemplated as an aspect of the present disclosure.

For example, in some embodiments, the carbonaceous particles may be natural graphite and/or synthetic graphite, and the negative electrode further comprises additional natural graphite, synthetic graphite, and/or graphitized fine coke, preferably wherein the additional natural graphite, synthetic graphite, and/or graphitized fine carbon is present in a minor amount, e.g. an amount ranging from 2% to 10%, or 3% to 5% by weight of the negative electrode.

The present disclosure also relates in another aspect to lithium ion batteries comprising a composition as defined herein as the active material in the negative electrode of the battery. Again, batteries wherein the negative electrodes contain mixtures with yet other carbonaceous particulate materials are also included in this aspect of the disclosure.

An electric vehicle, hybrid electric vehicle, or plug-in hybrid electric vehicle which comprises a lithium ion battery, wherein the lithium ion battery comprises a composition as defined herein as an active material in the negative electrode of the battery represents yet another aspect of the present disclosure.

In yet another aspect, the present disclosure relates to an energy storage device comprising the hydrophilic surface-modified carbonaceous particulate material according to the present disclosure.

A further aspect of the present disclosure relates to a carbon brush or a friction pad comprising the composition as defined herein.

Moreover, a further aspect of the present disclosure relates to polymer composite materials comprising, besides the polymer, the composition as defined herein, typically in a weight ratio of 5-95% by weight, preferably representing 10 to 85% by weight of the total composition.

In addition, a ceramic, ceramic precursor material, or a green material comprising the composition as defined herein as a pore forming material are further aspects of the present disclosure.

Yet another aspect of the present disclosure relates to a dispersion comprising a liquid, preferably water or water-based, and a composition as defined herein, wherein the dispersion has a low viscosity at a shear rate of 10 s⁻¹ of between 2000 and 4000 mPa·s in an aqueous dispersion containing 40 wt % of said carbonaceous material. Preferably the viscosity at this concentration and shear rate is between 2000 and 3000 mPa s, or between 2300 and 2600 mPa·s.

### Other Uses

A further aspect of the present disclosure relates to the use of a low spring-back carbonaceous particulate material having a spring-back of 5 about 18%, or 5 about 15% as a carbonaceous additive to increase the cell capacity and/or the cycling stability of a Li-ion battery while maintaining the power density of the cell compared to a cell with an anode absent the carbonaceous additive. An “additive” in this context means that the electrode comprises another carbonaceous material having a higher spring-back than the above-mentioned low spring-back carbonaceous particulate material as at least a significant portion (such as more than 30%, or more than 40% or more than 50% by weight) of the active material of the negative electrode of said Li-ion battery.

“Maintaining” in this context means that the power density of the cell does not decrease by more than 5%. In certain embodiments, the power density does not decrease by more than 3% or more than 2% compared to a cell without said carbonaceous additive. “Increasing” in this context should be understand to an increase of the respective cell parameter by at least 2%, at least 3%, at least 4% or at least 5%.

In some embodiments of this aspect, the low-spring-back carbonaceous particulate material may be further characterized by any of the additional parameters as described herein, such as a BET SSA of at least 5 m²/g, or at least 6 m²/g, or at least 7 m²/g, and/or being a high crystallinity graphite.

Typically, the low spring-back carbonaceous particulate material is added as a minor component to a composition of carbonaceous particles having a higher spring back, for example above 20%, which may be a surface-modified carbonaceous material as defined herein. In some embodiments, the content of said low spring-back carbonaceous particulate material to be added as a carbonaceous additive is less than 30%, or less than 20%, or between 1 and 20%, or between 2 and 15% by weight of the composition.

The use of said low spring-back material allows producing negative electrodes which convey a low per cycle loss to a Li-ion battery (cell) including said electrode. In some embodiments, the per cycle loss of such a cell between the 2^{nd} and 12^{th} charging cycle is ≤ about 0.1%. In other embodiments, the reversible cell capacity of such a cell is ≥350 mAh/g.

Another related aspect of the present disclosure refers to the use of said low spring-back carbonaceous particulate material as defined herein to increase the density of an electrode suitable for a Li-ion battery while maintaining the power density of the cell compared to a cell with an anode absent the carbonaceous additive.

“Maintaining” in this context means that the power density of the cell does not decrease by more than 5%. In certain embodiments, the power density does not decrease by more than 3% or more than 2% compared to a cell without said carbonaceous additive.

In some embodiments of this aspect, the low-spring-back carbonaceous particulate material may be further characterized by any of the additional parameters as described herein, such as a BET SSA of at least 5 m²/g, or at least 6 m²/g, or at least 7 m²/g, and/or being a high crystallinity graphite material.

Typically, the low spring-back carbonaceous particulate material in this aspect is added as a minor component to a composition of carbonaceous particles having a higher spring back, for example above 20%, which may be a surface-modified carbonaceous material as defined herein. In some embodiments, the content of said low spring-back carbonaceous particulate material to be added as a carbonaceous additive is less than 30%, or less than 20%, or between 1 and 20%, or between 2 and 15% by weight of the composition.

The resulting density of the electrode (using the same pressure) may in certain embodiments be increased by at least about 3%, 5%, 7%, or 10% compared to a cell with an anode absent the carbonaceous additive.

Suitable methods for determining the various properties and parameters used to define the compositions and carbonaceous materials described herein are set out in more detail below.

### Measurement Methods

The percentage (%) values specified herein are by weight, unless specified otherwise.

### Specific BET Surface Area, DFT Micropore and Mesopore Volume and Area

The method is based on the registration of the absorption isotherm of liquid nitrogen in the range p/p0=0.04-0.26, at 77 K. The nitrogen gas adsorption was performed on a Quantachrome Autosorb-1. Following the procedure proposed by Brunauer, Emmet and Teller (Adsorption of Gases in Multimolecular Layers, J. Am. Chem. Soc., 1938, 60, 309-319), the monolayer capacity can be determined. On the basis of the cross-sectional area of the nitrogen molecule, the monolayer capacity and the weight of sample, the specific surface can then be calculated. The isotherm measured in the pressure range p/p0 0.01-1, at 77 K was processed with DFT calculation in order to assess the pore size distribution, micro- and mesopore volume and area.
Reference: Ravikovitch, P., Vishnyakov, A., Russo, R., Neimark, A., Langmuir 16 (2000) 2311-2320; Jagiello, J., Thommes, M., Carbon 42 (2004) 1227-1232.

### Particle Size Distribution by Laser Diffraction

The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into the particle size distribution by means of a calculator. The method yields the proportion of the total volume of particles to a discrete number of size classes forming a volumetric particle size distribution (PSD). The particle size distribution is typically defined by the values D₁₀, D₅₀ and D₉₀, wherein 10 percent (by volume) of the particle population has a size below the D₁₀ value, 50 percent (by volume) of the particle population has a size below the D₅₀ value and 90 percent (by volume) of the particle population has a size below the D₉₀ value.

The particle size distribution data by laser diffraction quoted herein were measured with a MALVERN Mastersizer S. For determining the PSD, a small sample of a carbon material was mixed with a few drops of a wetting agent and a small amount of water. The sample prepared in the described manner was introduced in the storage vessel of the apparatus (MALVERN Mastersizer S) and after 5 minutes of ultrasonic treatment at intensity of 100% and the pump and stirrer speed set at 40%, a measurement was taken.
References: ISO 13320 (2009)/ISO 14887

### Oxygen Content

Oxygen mass fractions in solid samples were evaluated using the principles of inert gas fusion or solid carrier gas heat extraction. The sample was placed in a graphite crucible and inserted into an electrode furnace. The crucible was maintained between the upper and lower electrodes of an impulse furnace. A high current passed through the crucible after purging with inert gas (He or Ar) creating an increase of the temperature (above 2500° C.). Gases generated in the furnace were released into flowing inert gas stream. The gas stream was then sent to the appropriate infrared (O as CO by NDIR) or thermal conductivity (N and H by TCD) detectors for measurement. Instrument calibrations were performed using known reference materials.

### Wettability/Surface Energy Measurement

At 20° C., with a spatula 1 cm³ of graphite powder were spread on a microscope slide and pressed with a pressure of 1 bar in order to prepare a surface as flat as possible. Aqueous solutions with 2.7% weight% of 2-propanol were prepared with distilled, deionized water. The surface tension of such a solution is 59 mN m⁻¹ or 59 mJ/m² (extrapolated from Vazquez et al., J. Chem. Eng. Data, 1995, 40, 611-614). Afterwards, a drop of this solution with a total volume of 10 μL was placed on the powder surface using an Easy Drop device (Krüss GmbH, Hamburg, Germany).
Using Drop Shape Analysis DSA1 software (Krüss GmbH, Hamburg, Germany) employing Tangent Method 1 with system water (Ström et al., J. Colloid Interface Sci., 1987, 119, 352), the contact angle between the solution droplet and the powder was determined. A material is considered to be hydrophilic when the contact angle in this test is below 90°. If the contact angle is above 90°, the material is considered to be hydrophobic.

### pH Value:

1 g of graphite powder was dispersed in 50 ml of distilled water with 2 drops of imbentin™ and measured by a pH-meter with a calibrated pH electrode.

### Fe Content

This analysis was performed by an SDAR OES simultaneous emission spectrometer. Graphite powder, ground to a maximum particle size of 80 μm by means of a vibrated mill is compacted to a tablet. The sample was placed onto the excitation stand under argon atmosphere of the spectrometer. Subsequently the fully automatic analysis was initiated.

### Ash Content

A low-walled ceramic crucible was ignited at 800° C. in a muffle furnace and dried in a desiccator. A sample of 10 g of dry powder (accuracy 0.1 mg) was weighed in a low-walled ceramic crucible. The powder was combusted at a temperature of 815° C. to constant weight (at least 8 h). The residue corresponds to the ash content. It is expressed as a percentage of the initial weight of the sample.
References: DIN 51903 and DIN 51701 (dividing process), ASTM C 561-91

### Xylene Density

The analysis is based on the principle of liquid exclusion as defined in DIN 51 901. Approx. 2.5 g (accuracy 0.1 mg) of powder was weighed in a 25 ml pycnometer. Xylene was added under vacuum (15 Torr). After a few hours dwell time under normal pressure, the pycnometer was conditioned and weighed. The density represents the ratio of mass and volume. The mass is given by the weight of the sample and the volume is calculated from the difference in weight of the xylene filled pycnometer with and without sample powder.
Reference: DIN 51 901

### Scott Density (Apparent Density)

The Scott density was determined by passing the dry carbon powder through the Scott volumeter according to ASTM B 329-98 (2003). The powder was collected in a 1 in 3 vessel (corresponding to 16.39 cm³) and weighed to 0.1 mg accuracy. The ratio of weight and volume corresponds to the Scott density. The measurements were taken three times and the average value calculated.

The bulk density of graphite was calculated from the weight of a 250 ml sample in a calibrated glass cylinder.

### Tapped Density

100 g of dry graphite powder was carefully poured into a graduated cylinder. Subsequently, the cylinder was fixed on the off-centre shaft-based tapping machine and 1500 strokes were run. The reading of the volume was taken and the tap density was calculated.
Reference: -DIN-ISO 787-11

### Oil Absorption Number (Carbon Black)

Paraffin oil was added by means of a constant-rate burette to a dried (1 h at 125° C.) carbon black sample in the mixer chamber of the absorptometer. As the sample absorbed the oil, the mixture changed from a free-flowing state to one of a semi-plastic agglomeration, with an accompanying increase in viscosity. This increased viscosity is transmitted to the torque-sensing system. When the viscosity reached a predetermined torque level, the absorptometer and burette shut off simultaneously. The volume of the added oil was read from the burette. The volume of oil per unit mass of carbon black is the oil absorption number.

### Oil Absorption Number (Graphite)

A slow filter paper was placed into a special centrifuge metal tube having an inner diameter of 13.5 mm and a sieve on the bottom (18 mesh). In order to wet the filter, 0.5 g of paraffinic oil (Marco) 82 from Exxon Mobile) was filled into the tube and centrifuged for 30 minutes at 521 g (1 g=9.81 m/s², corresponding to 1500 rpm in the Sigma 6-10 centrifuge). After the wetting procedure, the tube was weighed and 0.5 g of graphite powder was added. The graphite was covered with 1.5 g of paraffinic oil and centrifuged for 90 minutes at 521 g. After centrifuging, the tube was weighed. The oil absorption per 100 g of graphite powder was calculated on the basis of the weight increase.
Imerys internal method

### Raman Spectroscopy

Raman analyses were performed using LabRAM-ARAMIS Micro-Raman Spectrometer from HORIBA Scientific with a 632.8 nm HeNe LASER. The ratio I_{D}/I_{G} was based on the ratio of intensities of the so-called band D and band G. These peaks are measured at 1350 cm⁻¹ and 1580 cm⁻¹, respectively, and are characteristic for carbon materials.

### Crystallite Size Lₐ

Crystallite size Lₐ may be calculated from Raman measurements using equation:

Lₐ[Angstrom]=C×(I_{G}/I_{D})

where constant C has values of 44[Å] and 58[Å] for lasers with wavelength of 514.5 nm and 632.8 nm, respectively. I_{G} and I_{D} are the intensities of the D- and G-band Raman absorption peaks at around 1350 cm⁻¹ and 1580 cm⁻¹, respectively.

### X-Ray Diffraction

XRD data were collected using a PANalytical X'Pert PRO diffractometer coupled with a PANalytical X'Celerator detector. The diffractometer has following characteristics shown in Table 1:

TABLE 1
Instrument data and measurement parameters

| Instrument | PANalytical X'Pert PRO |
|---|---|
| X-ray detector | PANalytical X'Celerator |
| X-ray source | Cu-K_{α} |
| Generator parameters | 45 kV-40 mA |
| Scan speed | 0.07°/s (for L_{c} and c/2) |
| | 0.01°/s (for [004]/[110] ratio) |
| Divergence slit | 1° (for L_{c} and c/2) |
| | 2° (for [004]/[110] ratio) |
| Sample spinning | 60 rpm |

The data were analyzed using the PANalytical X'Pert HighScore Plus software.

### Interlayer Spacing c/2

The interlayer space c/2 was determined by X-ray diffractometry. The angular position of the peak maximum of the [002] reflection profiles were determined and, by applying the Bragg equation, the interlayer spacing was calculated (Klug and Alexander, X-ray diffraction Procedures, John Wiley & Sons Inc., New York, London (1967)). To avoid problems due to the low absorption coefficient of carbon, the instrument alignment and non-planarity of the sample, an internal standard, silicon powder, was added to the sample and the graphite peak position was recalculated on the basis of the position of the silicon peak. The graphite sample was mixed with the silicon standard powder by adding a mixture of polyglycol and ethanol. The obtained slurry was subsequently applied on a glass plate by means of a blade with 150 μm spacing and dried.

### Crystallite Size L_{c}

Crystallite size was determined by analysis of the [002] diffraction profile and determining the widths of the peak profiles at the half maximum. The broadening of the peak should be affected by crystallite size as proposed by Scherrer (P. Scherrer, Gottinger Nachrichten 2, 98 (1918)). However, the broadening is also affected by other factors such X-ray absorption, Lorentz polarization and the atomic scattering factor. Several methods have been proposed to take into account these effects by using an internal silicon standard and applying a correction function to the Scherrer equation. For the present disclosure, the method suggested by Iwashita (N. Iwashita, C. Rae Park, H. Fujimoto, M. Shiraishi and M. Inagaki, Carbon 42, 701-714 (2004)) was used. The sample preparation was the same as for the c/2 determination described above.

### Spring-Back

The spring-back is a source of information regarding the resilience of compacted graphite powders. A defined amount of powder was poured into a die of 20 mm diameter. After inserting the punch and sealing the die, air was evacuated from the die. Compression force of 1.5 metric tons was applied resulting in a pressure of 0.477 t/cm² and the powder height was recorded. This height was recorded again after pressure had been released. Spring-back is the height difference in percent relative to the height under pressure.

### Adhesion

Adhesion was measured according to the standard T-peel test defined in D1876 (ASTM International), adapted according to the following procedure: The active material mixtures were prepared by combining the main and minor graphite components in the specified ratios with a shaker-mixer for 1 h. Aqueous slurries containing 97% active material, 1% CMC (carboxymethyl cellulose) and 2% SBR (styrene-butadiene rubber) were prepared, cast onto Cu foil at 160 μm and dried at 80° C. for 15 min and 150° C. overnight. A rectangular test specimen (3.5 cm×7.14 cm) was cut out from each sheet using a cutting die. Each specimen (25 cm²) was pressed at 400 kN for 1 s and subsequently placed coating down on the adhesive side of transparent tape. A narrow strip (˜5 3.5 cm) of non-adhesive paper was first placed parallel to the short side of the specimens. The transparent tape was cut out along the edges of the specimens. The non-adhesive paper allowed one to fold away two tabs, resulting in a T-shaped adhesion specimen. The tabs were attached to grips and mounted on a peel strength tester (LF Plus, Lloyd Instruments) with a 20 N load cell. Using Nexygen Plus software, a T-peel test was performed at a peeling rate of 100 mm/min and a crosshead limit of 150 mm. The adhesion was calculated by subtracting the average between 140 mm and 150 mm (specimen completely detached) from the average between 20 mm and 100 mm. To convert the adhesion to the T-peel strength (N/m), the obtained adhesion was divided by 0.035 m.

### Electrode Density

The electrode density of graphite electrodes on copper foil current collector (18 μm thickness) with a loading if 7-8 mg/cm² was measured. Disk-shaped test specimens with a diameter of 12 mm were punched out and pressed at 20 MPa (2 kN/cm²). Electrode densities were determined after releasing the pressure by measuring the electrode thickness with a height gauge (TESA-HITE) and calculating the density from the electrode mass (without copper foil) and the electrode volume.

### Electrochemical Measurements: ps Electrochemical Measurements

The graphite slurries were manufactured with a rotation-revolution mixer (THINKY, ARE-310), in a mass ratio of 98:1:1 graphite, CMC (carboxymethyl cellulose) and SBR (styrene-butadiene rubber). The graphite electrodes, whose loading was controlled at 7-8 mg/cm², were manufactured by coating the slurry onto copper foil. All electrodes were pressed to 1.7 g/cm³.

The electrochemical measurements were performed in 2032 coin cells at 25° C. The cells were assembled in a glove box filled with Ar, using a lithium electrode (14 mm diameter, 0.1 mm thickness), a polyethylene separator (16 mm diameter, 0.02 mm thickness), 200 μL of electrolyte (1M LiPF₆ in EC:EMC 1:3 v/v) and a graphite electrode (14 mm diameter).

After assembly, measurements were performed with a potentiostat/galvanostat (MACCOR, MODEL 4000). The cells were charged to 5 mV at 0.1 C (a C-rate of 0.1 C means that a complete half-cycle is completed in 1/0.1 =10 h), followed by a potentiostatic step until the current dropped to 0.005 C, and then discharged to 1.5 Vat 0.1 C. The capacity (specific charge) measured during discharge was defined as the reversible capacity. The difference between the capacity measured during charging and the reversible capacity was defined as the irreversible capacity, and the coulombic efficiency, which is defined as a percentage, was calculated by dividing the reversible capacity by the capacity measured during charging.

After adjusting the SOC to 50%, each coin cell was opened and the graphite electrode was reassembled into a new cell together with another graphite electrode that was also at 50% SOC. The obtained symmetric cells, whose voltage should be exactly 0 V, were connected to the potentiostat/galvanostat. The voltage after 20 s of discharge at 1 C divided by the current was defined as the electrode resistance.

As a measure of cycling stability, the per cycle capacity loss of charging cycles 2 to 12, which is expressed as a percentage, was calculated.

The high-current rate performance, which is expressed as a percentage, was calculated from the ratio of the reversible capacity measured at 2 C and 0.2 C discharge rate.

Having described the various aspects of the present disclosure in general terms, it will be apparent to those of skill in the art that many modifications and slight variations are possible without departing from the spirit and scope of the present disclosure.

### EXAMPLES

### Example 1

A number of high-spring-back surface-modified graphite materials were made according to a general method as outlined below. Table 2a summarizes the characteristics of these materials (particle size distribution, c/2, L_{c}, Lₐ, ratio I_{D}/I_{G}, BET SSA and spring-back).

### General Methods for Making Surface-Modified Carbonaceous Particulate Materials

Below is a generalized description how the various carbonaceous materials shown in the Examples can be obtained.

### Low Spring-back Components:

Synthetic graphite:

Petroleum based coke was graphitized at temperatures above 2500° C. under inert gas atmosphere and ground to the appropriate particle size distribution.
Natural flake graphite:

Chemically of thermally purified natural flake graphite was ground to the appropriate particle size distribution.

### High Spring-back Components:

### Method A:

Petroleum or coal based coke was ground and classified or sieved to adjust the desired particle size distribution and the fine coke then was graphitized under inert gas atmosphere at temperatures above 2500° C. The resulting graphite then was oxidized in air, carbon dioxide, water vapor, or oxygen, at temperatures of 600-1000° C. or ozone (at lower temperatures) using a continuously driven or batch rotary furnace, a tumbling bed reactor, a fluidized bed reactor, a fixed bed reactor, or a multiple hearth furnace.

### Method B:

Petroleum or coal based coke was graphitized at temperatures above 2500° C. and the resulting raw graphite was ground and shaped by mechanical treatment to reach the appropriate particle size distribution. The fine graphite then was surface treated in a mixture of hydrocarbon gas or alcohol vapors and nitrogen at temperatures between 600-1100° C. in a continuously driven or batch rotary furnace, a tumbling bed reactor, a fluidized bed reactor, a fixed bed reactor, or a multiple hearth furnace. Gas flow, partial pressure, type of precursor gas, residence time and feeding rate were chosen to reach the desired BET SSA, as is well known to those of skill in the art.

### Method C:

Chemically or thermally purified natural graphite was ground and shaped by mechanical treatment to reach the appropriate particle size distribution. The fine graphite was then surface treated in a mixture of hydrocarbon gas or alcohol vapors and nitrogen at temperatures between 600-1100° C. in a continuously driven or batch rotary furnace, a tumbling bed reactor, a fluidized bed reactor, a fixed bed reactor, or a multiple hearth furnace. Gas flow, partial pressure, type of precursor gas, residence time and feeding rate were chosen to reach the desired BET SSA, as is well known to those of skill in the art.

### Method D:

The graphite obtained by method B was further treated in air, carbon dioxide, water vapor, or oxygen atmosphere, at temperatures between 500° C. and 900° C. or ozone in a continuously driven or batch rotary furnace, a tumbling bed reactor, a fluidized bed reactor, a fixed bed reactor, or a multiple hearth furnace.

### Method E:

The graphite obtained by method C was further treated in air, carbon dioxide, water vapor, or oxygen atmosphere, at temperatures between 500° C. and 900° C. or ozone in a continuously driven or batch rotary furnace, a tumbling bed reactor, a fluidized bed reactor, a fixed bed reactor, or a multiple hearth furnace.

It is noted that the oxidation treatment can also be conveniently carried out at lower temperatures, or even ambient temperatures, especially when employing the highly reactive gas ozone.

The high-spring-back surface-modified graphite materials were then combined as a main component with a varying amount of several low-spring-back graphite materials, whose characteristics are summarized in Table 2b (particle size distribution, c/2, L_{c}, BET SSA, Scott density, oil absorption, spring-back and Xylene density), in a shaker-mixer for about 1 h to obtain an active material mixture.

The active material mixture was subsequently treated with water to obtain an aqueous graphite slurry containing 97% of the above specified active material. The graphite slurry was prepared with a rotation-revolution mixer (THINKY, ARE-310), in a mass ratio of 98:1:1 graphite, CMC (carboxymethyl cellulose) and SBR (styrene-butadiene rubber). The graphite electrode, whose loading was controlled between 7 mg/cm² and 8 mg/cm², was manufactured by coating the slurry onto copper foil (thickness 18 μm). The electrode was pressed to a density of 1.7 g/cm³.

TABLE 2a
Properties of various high-spring-back graphite component

| | Graphite | | | | |
|---|---|---|---|---|---|
| | Graphite | Graphite | Graphite | Graphite | Graphite |
| | A | M | G | L | K |
| Particle | Malvern | Malvern | Malvern | Malvern | Malvern |
| size | | | | | |
| distribution | | | | | |
| (μm) | | | | | |
| D₁₀ | 6 | 12 | 12 | 5 | 6 |
| D₅₀ | 14 | 18 | 19 | 12 | 14 |
| D₉₀ | 29 | 29 | 29 | 25 | 27 |
| c/2 (002) | 0.3359 | 0.3356 | 0.3356 | 0.3357 | 0.3357 |
| in nm | | | | | |
| L_{c} (002) | 130 | 230 | 230 | 130 | 130 |
| in nm | | | | | |
| Lₐ (Raman) | 30 | 8 | 8 | 8 | 7 |
| in nm | | | | | |
| Ratio I_{D}/I_{G} | 0.2 | 0.7 | 0.77 | 0.75 | 0.82 |
| BET in m²/g | 2.9 | 3.5 | 4.4 | 2.7 | 4.5 |
| Spring-back | 53 | 20 | 21 | 57 | 60 |
| in % | | | | | |
| Process | Method A | Method C | Method E | Method B | Method D |

| | Graphite | | | |
|---|---|---|---|---|
| | Graphite | Graphite | Graphite | Graphite |
| | C | D | E | F |
| Particle | Malvern | Malvern | Malvern | Malvern |
| size | | | | |
| distribution | | | | |
| (μm) | | | | |
| D₁₀ | 7 | 6 | 9 | 13 |
| D₅₀ | 16 | 17 | 19 | 22 |
| D₉₀ | 32 | 38 | 36 | 35 |
| c/2 (002) | 0.3358 | 0.3357 | 0.3356 | 0.3356 |
| in nm | | | | |
| L_{c} (002) | 140 | 160 | 310 | 320 |
| in nm | | | | |
| Lₐ (Raman) | 20 | 9 | 8 | 15 |
| in nm | | | | |
| Ratio I_{D}/I_{G} | 0.35 | 0.65 | 0.72 | 0.37 |
| BET in m²/g | 3.4 | 3.5 | 3.3 | 3.5 |
| Spring-back | 58 | 60 | 45 | 24 |
| in % | | | | |
| Process | Method D | Method D | Method D | Method D |

TABLE 2b
Properties of various low-spring-back graphite components

| Graphite | Graphite 1 | Graphite 2 | Graphite 3 | Graphite 4 | Graphite 5 | Graphite 6 |
|---|---|---|---|---|---|---|
| Origin | synthetic | synthetic | synthetic | synthetic | synthetic | natural |
| | | | | | | purif. flake |
| PSD | | | | | | |
| D₁₀ | 1.7 | 2.9 | 3.2 | 5.0 | 2.9 | 3.1 |
| D₅₀ | 3.6 | 6.2 | 7.7 | 12.1 | 6.9 | 7.4 |
| D₉₀ | 6.4 | 11.2 | 15.6 | 25.7 | 13.9 | 15.2 |
| c/2 (002) | 0.3357 | 0.3357 | 0.3357 | 0.3357 | 0.3358 | 0.3355 |
| in nm | | | | | | |
| L_{c} (002) | 93 | 133 | 171 | 238 | 90 | 210 |
| in nm | | | | | | |
| BET in m²/g | 16.2 | 10.2 | 9.6 | 8.1 | 12.2 | 8.2 |
| Scott | 0.059 | 0.055 | 0.061 | 0.080 | 0.112 | 0.058 |
| density | | | | | | |
| in g/cm³ | | | | | | |
| Oil | 175 | 179 | 172 | 155 | 148 | 170 |
| absorption | | | | | | |
| Spring- | 10.6 | 9.8 | 10.1 | 11.4 | 14.5 | 6.5 |
| back in % | | | | | | |
| Xylene | 2.259 | 2.262 | 2.264 | 2.264 | 2.250 | 2.263 |
| density in | | | | | | |
| g/cm³ | | | | | | |

### Example 2

Following the procedure described in Example 1 a high spring-back graphite (Graphite A) was mixed as the main component with a low-spring-back graphite to produce a negative electrode. Specific wt % of the employed high-spring-back graphite and low-spring-back graphite are given in Table 3. Electrochemical measurements characterizing the obtained graphite negative electrode are also shown in Table 3.

TABLE 3
Reversible capacity and cycling stability characterization of a negative
electrode produced with an exemplary graphite composition

| Main graphite | Minor graphite | | Reversible | Cycling |
|---|---|---|---|---|
| component | component | wt % | capacity | stability (%)* |
| Graphite | Graphite | 0** | 341.5 | 0.123 |
| A | 3 | 10 | 344.4 | 0.067 |
| | | 20 | 347.8 | 0.073 |

*per cycle loss capacity of 2^{nd}-12^{th} charging cycle
**comparative example

### Example 3

Following the procedure described in Example 1 another high-spring-back graphite (Graphite C) was mixed as the main component with low-spring-back graphite to produce a graphite negative electrode. Specific wt % of the employed high-spring-back graphite and low-spring-back graphite are given in Table 4. Electrochemical measurements characterizing the obtained graphite negative electrode are also shown in Table 4.

TABLE 4
Electrode resistance, reversible capacity, high current rate
performance characterization of various graphite negative
electrode produced with exemplary graphite compositions

| | | | | Rev. | High |
|---|---|---|---|---|---|
| Main | Minor | | Elec- | Capacity | current |
| graphite | graphite | | trode | (specific | rate |
| compo- | compo- | wt | resistance | charge) | performance |
| nent | nent | % | (Ohm) | (mAh/g) | 2 C/0.2 C |
| Graphite | Graphite | 0* | 30.3 Ω | 348 mAh/g | 97% |
| C | 3 | 2.5 | 27.0 Ω | 348 mAh/g | |
| | | 5 | 29.2 Ω | 350 mAh/g | 97% |
| | | 15 | 29.7 Ω | 355 mAh/g | 93% |
| | | 30 | 47.3 Ω | 357 mAh/g | 73% |
| | | 100* | 46.3 Ω | 363 mAh/g | 68% |
| Graphite | Graphite | 5 | 26.4 Ω | 355 mAh/g | |
| C | 1 | 15 | 28.8 Ω | 357 mAh/g | |
| | | 30 | 29.9 Ω | 360 mAh/g | |
| | Graphite | 5 | 29.7 Ω | 350 mAh/g | |
| | 2 | 5 | 28.7 Ω | 351 mAh/g | |
| | | 15 | 20.4 Ω | 353 mAh/g | |
| | | 30 | 24.7 Ω | 351 mAh/g | |

*comparative example

As Table 4 illustrates, the low spring-back graphite material was found to decrease electrode resistance at relatively lower amounts, however, at higher amounts caused an increase in resistance. Yet, increasing the amount of the low spring-back graphite material resulted in a consistent increase in the reversible capacity of the electrode. This suggests that there is a threshold amount at which additional low-spring graphite material begins to adversely impact battery performance. The current rate performance data for the compositions of Graphite C and Graphite 3 suggest that performance declines considerably when the low spring-back graphite material is greater than about 15% to 30% by weight.

### Example 4

Following the procedure described in Example 1 high-spring-back graphite was mixed as the main component with low-spring-back graphite to produce a graphite negative electrode. Specific wt % of the employed high-spring-back graphite and low-spring-back graphite are given in Table 5. Electrode parameters characterizing the obtained graphite negative electrode are also shown in Table 5.

TABLE 5
Adhesion and electrode density characterization of a graphite
negative electrode produced with an exemplary composition

| Main | Minor | | | Electrode density |
|---|---|---|---|---|
| graphite | graphite | wt | Adhesion | (20 MPa) |
| component | component | % | (N/m) | (g/cm³) |
| Graphite | Graphite | 0* | 7.32 | 1.397 |
| C | 3 | 5 | 5.03 | 1.495 |
| | | 15 | 8.23 | 1.582 |
| | | 30 | 7.20 | 1.646 |
| | | 100* | 5.39 | 1.987 |
| Graphite | Graphite | 5 | 7.97 | 1.430 |
| C | 1 | 15 | | 1.499 |
| | | 30 | | 1.597 |
| | Graphite | 5 | 6.29 | 1.46 |
| | 2 | | | |
| | Graphite | 5 | 10.98 | 1.49 |
| | 4 | 15 | | 1.657 |
| | | 30 | | 1.674 |

*comparative examples

### Example 5

Following the procedure described in Example 1 a specific mixture of two high-spring-back graphites were mixed with low-spring-back graphite to produce a graphite negative electrode. Ratio of the employed high-spring-back graphite mixture and specific wt % of the low-spring-back graphite component are given in Table 6. Electrochemical measurements characterizing the obtained graphite negative electrode are also shown in Table 6.

TABLE 6
Reversible capacity and cycling stability characterization
of another graphite negative electrode produced with a
mixture of two high spring-back surface modified graphites
and a low spring-back graphite as the minor component

| Main | Minor | | Reversible | Cycling |
|---|---|---|---|---|
| graphite | graphite | wt | capacity | stability |
| component | component | % | (mAh/g) | (%)* |
| Graphite A/Graphite C | Graphite | 0** | 347.2 | 0.135 |
| 40:60 | 3 | | | |
| Graphite A/Graphite C | | 2 | 348.5 | 0.0930 |
| 40:58 | | | | |
| Graphite A/Graphite C | | 5 | 351.2 | 0.0839 |
| 37:58 | | | | |
| Graphite A/Graphite C | | 8 | 355.1 | 0.0687 |
| 34:58 | | | | |

*per cycle loss capacity of 2^{nd}-12^{th} charging cycle
**comparative example

1. A composition comprising:
at least one surface-modified carbonaceous particulate material; and
at least one low spring-back carbonaceous particulate material having a lower spring-back than the at least one surface-modified carbonaceous particulate material.

2. The composition according to claim 1, wherein the surface-modified carbonaceous particulate material is a high spring-back surface-modified carbonaceous particulate material having a spring-back of equal to or more than 20% and/or wherein the at least one low spring-back carbonaceous material particulate material has a spring-back of equal to or below about 18.

3. The composition according to claim 1, wherein the BET SSA of the low spring-back carbonaceous particulate material is higher than the BET SSA of the surface-modified carbonaceous particulate material.

4. The composition according to claim 1, wherein the at least one surface-modified carbonaceous particulate material has a BET SSA of less than 20 m²/g.

5. The composition according to claim 4, wherein the surface-modified carbonaceous particulate material is further characterized by any one of the following parameters, alone or in combination:
a. a ratio of L_{c}/Lₐ of greater than 1.0;
b. a crystallite size L_{c} (as measured by XRD) from 50 to 400 nm;
c. a crystallite size Lₐ (as measured by Raman spectroscopy) from 5 to 100;
d. a c/2 distance of between 0.3353-0.3370 nm;
e. an oxygen content of greater than 50 ppm;
f. a Fe content of below 20 ppm; and/or
g. an ash content of below 0.04.

6. The composition according to claim 4, wherein the at least one surface-modified carbonaceous particulate material is further characterized by
a. a pH value ranging from 5.0 to 7.0;
b. a xylene density from 2.24 to 2.26 g/cm³; and/or
c. exhibiting an I_{D}/I_{G} ratio (R(I_{D}/I_{G})) of below about 0.3 when measured with a laser having an excitation wavelength of 632.8 nm.

7. (canceled)

8. The composition according to claim 1, wherein the at least one surface-modified carbonaceous material is characterized by comprising carbonaceous core particles with a non-graphitic carbon coating.

9. (canceled)

10. (canceled)

11. The composition according to claim 8, wherein the non-graphitic carbon coating of said at least one surface-modified carbonaceous particulate material is a hydrophilic non-graphitic carbon coating; and wherein said at least one hydrophilic surface-modified carbonaceous particulate material of the composition exhibits a wettability characterized by
(i) a contact angle after 3 seconds that is less than 90°, or less than 75°, less than 70°, or less than 65°, and/or a contact angle after 5 seconds that is less than about 60°, or less than 40°, less than 30°, less than 25°, or less than 20°; and/or
(ii) a surface energy of said hydrophilic surface-modified carbonaceous particulate material of at least 59 mJ/m².

12. The composition according to claim 11, wherein the carbon coating of said hydrophilic surface-modified carbonaceous particulate material is comprised of oxidized amorphous carbon.

13. The composition according to claim 11, wherein the at least one hydrophilic surface-modified carbonaceous particulate material in the composition is further characterized by
(i) an oxygen content of greater than about 200 ppm; and/or
(ii) a mesopore area of less than 10.0 m²/g.

14. (canceled)

15. The composition according to claim 1, wherein the carbonaceous particles forming the core of said at least one surface-modified carbonaceous particulate material are selected from natural graphite, synthetic graphite, coke, hard carbon, graphitized fine coke, mixtures thereof, or compositions of such carbon particles which further contain silicon, tin, bismuth, antimony, aluminum, silver, SiO_{X} (X=0.2-1.8), or SnOₓ (including SnO and SaO₂) particles.

16. (canceled)

17. The composition according to claim 1, wherein the low spring-back carbonaceous particulate material is selected from natural graphite, synthetic graphite, coke, exfoliated graphite, graphene, few-layer graphene, graphite fibers, nanographite, non-graphitic carbon, carbon black, petroleum- or coal based coke, glassy carbon, carbon nanotubes, fullerenes, carbon fibers, hard carbon, graphitized fine coke, or mixtures thereof, or compositions of such carbon particles which further contain silicon, tin, bismuth, antimony, aluminum, silver, SiO_{X} (X=0.2-1.8), or SnOₓ (including SnO and SnO₂) particles.

18. The composition according to claim 1, wherein the at least one low spring-back carbonaceous material has not been surface-modified by oxidation and/or non-graphitic carbon coating.

19. The composition according to claim 1, wherein the at least one low spring-back carbonaceous material is a highly crystalline graphite, characterized by any one of the following parameters, alone or in combination:
a. a BET SSA o re than about 5 m²/g;
b. a particle size distribution (D₉₀) ranging from 3 to 50 μm;
c. a particle size distribution (D₅₀) ranging from 1 to 30 μm;
d. a particle size distribution (D₁₀) ranging from 0.5 to 10 μm;
e. a crystallite size L_{c} (as measured by XRD) from 30 to 400 nm;
f. a Scott density of less than about 0.4 g cm³;
g. a xylene density from 2.24 to 2.27 g/cm³;
h. exhibiting an I_{D}/I_{G} ratio (R(I_{D}/I_{G})) of below about 0.3 when measured with a laser having an excitation wavelength of 632.8 nm and/or
i. a c/2 distance of equal to or smaller than 0.3370 nm.

20. (canceled)

21. (canceled)

22. The composition according to claim 1, wherein the content of the low spring-back carbonaceous particulate material is below about 30% by weight of the composition.

23. (canceled)

24. (canceled)

25. The composition according to claim 1, wherein the composition further comprises a polymer binder material, and wherein the content of said polymer binder is between about 1% and about 5% by weight of the composition.

26. (canceled)

27. The composition according to claim 1, wherein the at least one surface-modified carbonaceous particulate material has a spring-back that is at least 2% greater than the spring-back of the at least one low spring-back carbonaceous particulate material.

28. The composition according to claim 1, wherein the at least one surface-modified carbonaceous particulate material has a spring-back ranging from about 25% to about 65% and the at least one low spring-back carbonaceous particulate material has a spring-back ranging from about 5% to about 15.

29. The composition according to claim 1, wherein the composition comprises at least 75% by weight of the at least one surface-modified carbonaceous particulate material, and from 2% to 15% by weight of the at least one low spring-back carbonaceous material.

30. The composition according to claim 1, wherein the composition further comprises carbon black.

31-42. (canceled)
